(19) United States
(12) Patent Application Publication
(10) Pub. No.: US 2005/0200722 A1
(43) Pub. Date: Sep. 15, 2005

(54) Image capturing apparatus, image capturing method, and machine readable medium storing thereon image capturing program

(75) Inventor: Shuji Ono, Tokyo (JP)

Correspondence Address: BIRCH STEWART KOLASCH & BIRCH, PO BOX 747, FALLS CHURCH, VA, 22040-0747, US

(73) Assignee: Fuji Photo Film Co., Ltd., Minami-Ashigara-shi (JP)

(21) Appl. No.: 11/078,411

(22) Filed: Mar. 14, 2005

(30) Foreign Application Priority Data
Mar. 15, 2004 (JP) 2004-073602
Feb. 28, 2005 (JP) 2005-053724

(51) Int. Cl. H04N 5/228; G06K 9/00

(52) U.S. Cl. 348/222.1

(57) ABSTRACT

An image capturing apparatus including an image capturing unit for capturing an image, an evaluation value acquiring unit for evaluating the image captured by the image capturing unit with a predetermined reference and acquiring an evaluation result as an evaluation value, and an image processing unit for performing an image processing on the image captured by the image capturing unit on the basis of the evaluation value acquired by the evaluation value acquiring unit, is provided.

This patent application claims priority from a Japanese patent application Nos. 2004-073602 filed on Mar. 15, 2004, and 2005-053724 filed on Feb. 28, 2005, the contents of which are incorporated herein by reference.

### BACKGROUND OF THE INVENTION

1. Field of the Invention

The present invention relates to an image capturing apparatus, an image capturing method, and a machine readable medium storing thereon an image capturing program. More particularly, the present invention relates to an image capturing apparatus and an image capturing method for performing image processing on a captured image and a machine readable medium storing thereon a program for making the image capturing apparatus function.

2. Description of the Related Art

Recently, a digital camera has come into wide use. The digital camera stores an image not by exposing a film to light like a silver salt film camera but electrically by using a recording medium such as a semiconductor memory. Here, storage and deletion of image data can be repeated on the recording medium such as the semiconductor memory used in the digital camera, while the recording medium is more expensive than a common film.

Recently, although memory volume of the recording medium which can be used in a digital camera increases, the size of the image data becomes larger due to an increase in the number of pixels of a CCD included in the digital camera and many users capture the rest of the memory volume of the recording medium into consideration when they use the digital camera.

Further, in case an object is a human being, a technique for storing only an image in which the object captured on a smiling expression out of captured images by recognizing a facial expression of the object, is disclosed (for example, see Japanese Patent Application Laying Open No. 2002-24229). The technique reduces a problem that a captured image cannot be stored because the recording medium does not have free memory volume.

In case it cannot be said that all images, which do not satisfy a condition, such as the object's capturing on a smiling expression, are valueless to a user, the user may want to use the images. However, in case the images are not stored, the user cannot use the images and thus convenience is deteriorated.

### SUMMARY OF THE INVENTION

Therefore, it is an object of the present invention to provide an image capturing apparatus, an image capturing method, and a machine readable medium storing thereon an image capturing program, which are capable of overcoming the above drawbacks accompanying the conventional art. The above and other objects can be achieved by combinations described in the independent claims. The dependent claims define further advantageous and exemplary combinations of the present invention.

According to the first aspect of the present invention, an image capturing apparatus includes: an image capturing unit for capturing an image; an evaluation value acquiring unit for evaluating the image captured by the image capturing unit with a predetermined reference and acquiring an evaluation result as an evaluation value; and an image processing unit for performing an image processing on the image captured by the image capturing unit on the basis of the evaluation value acquired by the evaluation value acquiring unit. The image capturing apparatus may further include a storing unit for storing the image on which the image processing is performed by the image processing unit by corresponding it to the evaluation value acquired by the evaluation value acquiring unit.

The image processing apparatus may further include a memory volume detecting unit for detecting whether or not a memory volume available for usage of the storing unit is smaller than a predetermined value, wherein the image processing unit may further perform an image processing on the image on the basis of the evaluation value corresponding to the image stored by the storing unit in case the memory volume available for usage of the storing unit is detected not to be smaller than the predetermined value. The image processing unit may perform an image compression processing on the image captured by the image capturing unit by using an image compression rate determined on the basis of the evaluation value acquired by the evaluation value acquiring unit. The image processing unit may change a gradation number of the image captured by the image capturing unit to a gradation number determined on the basis of the evaluation value acquired by the evaluation value acquiring unit. The image processing unit may change a resolution of the image captured by the image capturing unit to a resolution determined on the basis of the evaluation value acquired by the evaluation value acquiring unit.

The image capturing unit may capture an moving picture, the evaluation value acquiring unit may evaluate each image of at least a part of frames of the moving picture by a predetermined reference and acquires the evaluation value for the frame image, and the image processing unit may perform the image processing on the moving picture on the basis of the acquired evaluation value. The image processing unit may perform an image compression processing on the moving picture by using a frame image of a higher evaluation value acquired as a key frame with higher priority.

According to the second aspect of the present invention, an image capturing method includes: an image capturing method including: an image capturing step of capturing an image; an evaluation value acquiring step of evaluating the image captured in the image capturing step with a predetermined reference and acquiring an evaluation result as an evaluation value; and an image processing step of performing an image processing on the image captured in the image capturing step on the basis of the evaluation value acquired in the evaluation value acquiring step. The image capturing method may further include a storing step of storing the image on which the image processing is performed in the image processing step by corresponding it to the evaluation value acquired in the evaluation value acquiring step.

According to the third aspect of the present invention, a machine readable medium storing thereon a computer program making an image capturing apparatus perform as the image capturing apparatus includes: an image capturing unit for capturing an image; an evaluation value acquiring unit for evaluating the image captured by the image capturing unit with a predetermined reference and acquiring an evaluation result as a evaluation value; and an image processing unit for performing an image processing on the image captured by the image capturing unit on the basis of the evaluation value acquired by the evaluation value acquiring unit. The image capturing apparatus may further include a storing unit for storing the image on which the image processing is performed by the image processing unit by corresponding it to the evaluation value acquired by the evaluation value acquiring unit.

The summary of the invention does not necessarily describe all necessary features of the present invention. The present invention may also be a sub-combination of the features described above. The above and other features and advantages of the present invention will become more apparent from the following description of the embodiments taken in conjunction with the accompanying drawings.

### BRIEF DESCRIPTION OF THE DRAWINGS

FIG. 1 is a block diagram showing an example of the configuration of a digital camera 10 according to an embodiment of the present invention.

FIG. 2 shows an example of evaluation values acquired by an evaluation value acquiring unit 130 according to an embodiment of the present invention.

FIG. 3 shows another example of evaluation values acquired by the evaluation value acquiring unit 130 according to an embodiment of the present invention.

FIG. 4 is a flowchart showing a process flow of the digital camera 10 according to an embodiment of the present invention.

FIG. 5 is a block diagram showing an example of the configuration of a computer system 1500 according to an embodiment of the present invention.

### DETAILED DESCRIPTION OF THE INVENTION

The invention will now be described based on the preferred embodiments, which do not intend to limit the scope of the present invention, but exemplify the invention. All of the features and the combinations thereof described in the embodiment are not necessarily essential to the invention.

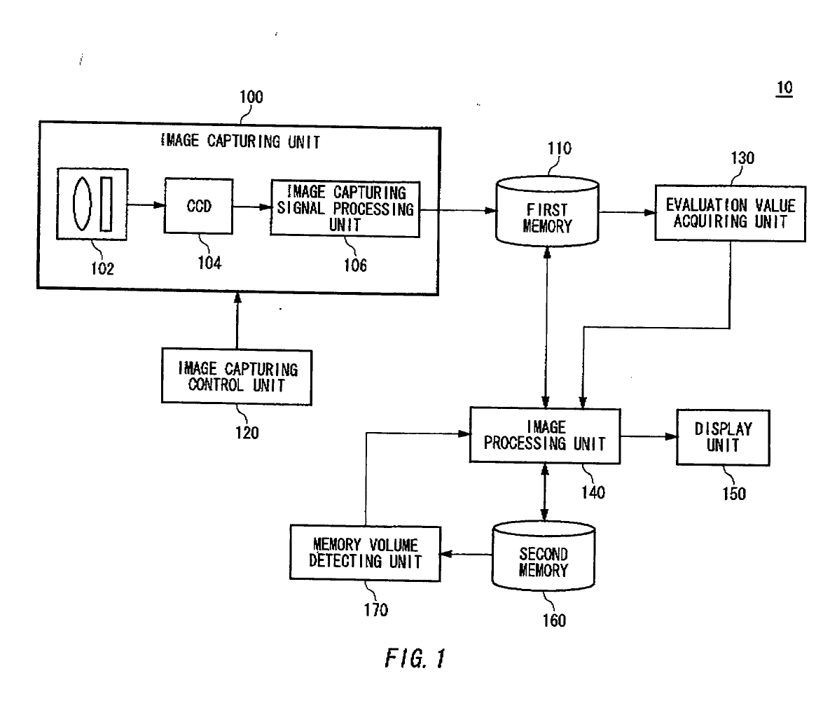

FIG. 1 is a block diagram showing an example of the configuration of a digital camera 10 according to an embodiment of the present invention. The digital camera 10 is an example of the image capturing apparatus according to the present invention and captures an image of an object. The digital camera includes an image capturing unit 100, a first memory 110, an image capturing control unit 120, an evaluation value acquiring unit 130, an image processing unit 140, a display unit 150, a second memory 160, and a memory volume detecting unit 170. Further, the digital camera 10 may captures a still image or a moving picture. In the following, the digital camera 10 capturing a still picture is given as an example.

It is an object of the digital camera 10 according to the embodiment of the present invention to be capable of evaluating captured images by a predetermined reference value, performing an image compression processing on an image of which evaluation is low, that is, an image which the user judges to be of no importance, by using a higher compression rate than another image, and thus storing many images in the second memory 160 by making data amount of the image smaller.

The image capturing unit 100 includes an optical system 102, a CCD, and an image capturing signal processing unit 106, and captures an image of the object. The optical system 102 includes a focus lens, a zoom lens, and the like, and forms an image of the object on a light receiving surface of the CCD 104. The CCD 104 includes a plurality of light receiving elements and outputs electric charges accumulated in each light receiving element due to the optical image of the object formed on the light receiving surface by the optical system 102 as an analog electric signal to the image capturing signal processing unit 106.

The image capturing signal processing unit 106 decomposes the analog signal showing the image of the object into R, G, and B components. Then, the image capturing signal processing unit 106 converts the analog signal which is decomposed into the R, G, and B components into a digital signal and outputs digital image data obtained as a result and showing the image of the object to the first memory 110. The first memory 110 is a volatile memory such as a DRAM and stores the digital image data output by the image capturing signal processing unit 106. The image capturing control unit 120 drives a machinery member included in the image capturing unit 100 and thus controls image capturing of an image showing the object. For example, the image capturing control unit 120 controls exposure, white balance, zooming, stopping, etc.

The evaluation value acquiring unit 130 evaluates the digital image data stored in the first memory 110 by a predetermined reference value and acquires the result of the evaluation as a evaluation value. Here, the evaluation value is an index showing which degree of importance the image is judged to have by the user. For example, a higher evaluation value shows that an image is judged to be more important by the user. Specifically, the predetermined reference value is a facial expression, and the like. More specifically, an image of a smiling expression of a person who is the object shows a higher evaluation value than that of an angry expression. Then, the evaluation value acquiring unit 130 outputs the acquired evaluation value to the image processing unit 140.

The image processing unit 140 performs an image processing on the image data stored in the first memory 110. Here, the image processing is a data compression process, such as an YC conversion processing and JPEG (Joint Photographic Coding Experts Group), and a processing for converting to a video signal such as NTSC and PAL. Further, the image processing unit 140 performs the image processing on the image data on the basis of the evaluation value acquired by the evaluation value acquiring unit 130. Specifically, the image processing unit 140 performs the image processing on an image of which acquired evaluation value is low so as to reduce data amount of the image. Then, the image processing unit 140 outputs the image data on which the image processing is performed to the display unit 150. Further, the image processing unit 140 outputs the image data on which the image processing is performed and the evaluation value of the image corresponding to the image data to the second memory 160.

The display unit 150 is a display apparatus such as an electronic view finder, for example, using a liquid crystal panel and displays the image data received from the image processing unit 140 to provide to the user. The second memory 160 is a non-volatile memory such as a flash memory and stores the image data on which the image processing is performed by the image processing unit 140 so that the image data corresponds to the evaluation value acquired by the evaluation value acquiring unit 130. The second memory 160 is an example of a storing unit of the present invention. The memory volume detecting unit 170 acquires available memory volume of the second memory 160 and thus detects whether or not the available memory volume is smaller than a predetermined reference value. Then, the memory volume detecting unit 170 outputs the result to the image processing unit 140.

According to the digital camera 10 of the present embodiment, it is possible to use limited memory volume of the second memory 160 efficiently and store much more images by performing an image processing on an image, which the user judges to be of no importance out of images captured by the image capturing unit 100, so as to reduce amount of image data.

Further, according to the digital camera 10 of the present embodiment, even an image of which acquired evaluation value is low is not deleted but stored after the data amount is reduced. Therefore, the user can use the image in case the image is required and thus it is possible to improve convenience.

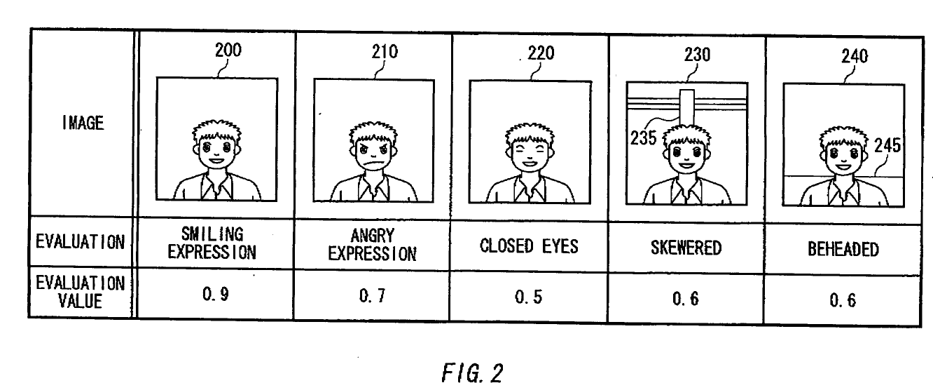

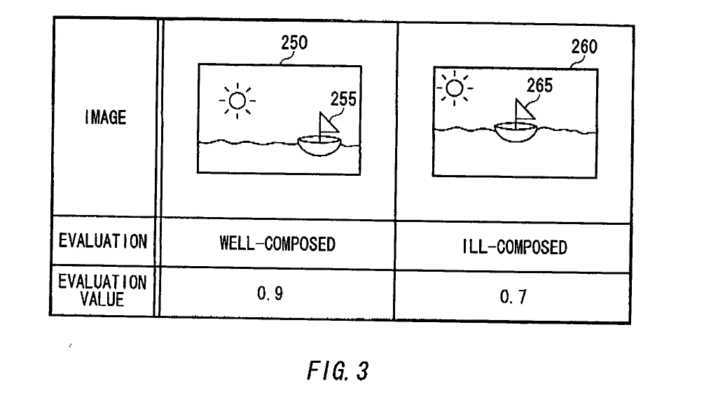

FIG. 2 shows an example of evaluation values acquired by the evaluation value acquiring unit 130 according to the embodiment of the present invention. Further, FIG. 3 shows another example of evaluation values acquired by the evaluation value acquiring unit 130 according to the embodiment of the present invention. In case acquiring an evaluation value of an image captured by the image capturing unit 100, the evaluation value acquiring unit 130 can use various references or methods of acquisition. The evaluation value acquiring unit 130 acquires the evaluation value on the basis of the result of performing the image processing on the captured image. Here, in order to acquire an evaluation value of high accuracy from the captured image, that is, an evaluation value reflecting more accurately importance of the image judged by the user, it is preferable that the evaluation value acquiring unit 130 detects accurately a main object of the captured image and determines a reference and a method of acquisition of the evaluation value on the basis of the result.

For example, the evaluation value acquiring unit 130 performs an edge extracting processing on the captured image and thus detects a region showing each of a plurality of objects existing in the image. Then, the evaluation value acquiring unit 130 detects an object which is a human being by performing a pattern matching on a region showing each object or on the basis of a ratio of skin color included in the region showing each object in distribution of the region of the captured image. Then, in case the size of the region showing the detected object is equal to or larger than a reference value, the evaluation value acquiring unit 130 detects the object as a main object. Here, in case a plurality of objects are detected as the main object, the evaluation value acquiring unit 130 may detects only an object of which region is largest, that is, an object which is closest to the digital camera 10 as the main object, for example.

Further, for example, the evaluation value acquiring unit 130 may detect a main object on the basis of an instruction of the user. Specifically, in case the user instructs where the main object exists in an image while looking at the image displayed on a display such as the electronic view finder by using an instruction means provided in the digital camera 10, the evaluation value acquiring unit 130 may detect which one of a plurality of objects included in the captured image is the main object on the basis of contents of the instruction.

Further, for example, the evaluation value acquiring unit 130 may detect a main object on the basis of an operation mode of the digital camera 10. Specifically, the evaluation value acquiring unit 130 may detect an object near the center of a captured image as the main object in case the operation mode of the digital camera is a portrait mode. In the following, a reference and a method for acquiring an evaluation value are described using an example.

In case a main object is a human being, the evaluation value acquiring unit 130 acquires an evaluation value on the basis of a facial expression of the object. Specifically, the evaluation value acquiring unit 130 extracts an image of the face by using a method such as the pattern matching. Then, the evaluation value acquiring unit 130 recognizes a facial expression of the main object when the image of the main object is captured by performing the pattern matching on each part of the extracted face image, such as eyes, a mouth, etc. by using a plurality of pattern data each of which has different facial expression. Here, the evaluation value acquiring unit 130 may analyze the face image by using a well-known recognition technique or perform the pattern matching by recognizing which person is the main object by making the user input by using an inputting means not shown and using the data patterns which have different facial expressions and are previously made for each part of the person, such as eyes, a mouth, etc. Thus, it is possible to recognize a facial expression more accurately by using the pattern data of each person. Then, the evaluation value acquiring unit 130 acquires a lower evaluation value for an angry expression 210 than a smiling expression 200, for example. Further, the evaluation value acquiring unit 130 acquires a lower evaluation value for an expression with closed eyes 220 than the expressions with open eyes 200 and 210.

Further, in case a main object is a human being, the evaluation value acquiring unit 130 may an evaluation value on the basis of a positional relationship between the main object and objects included in the background. Specifically, the evaluation value acquiring unit 130 detects a contour shape or a line of each of the objects included in the background and acquires an evaluation value on the basis of a positional relationship between the main object and the contour shape or the line. For example, the evaluation value acquiring unit 130 acquires a lower evaluation value for an image in which an object 235 included in the background image pierces vertically a main object, that is, an image of the so called “skewered” composition like an image 230 than another images such as the image 200. Further, for example, the evaluation value acquiring unit 130 acquires a lower evaluation value for an image in which a line 245 such as the horizon pierces horizontally the neck of a main object, that is, an image of the so called “beheaded” composition like an image 240 than another images such as the image 200.

The evaluation value acquiring unit 130 may acquire an evaluation value on the basis of a result of evaluating the composition of a whole image by a reference such as trisection method. For example, the evaluation value acquiring unit 130 acquires a higher evaluation value for an image in which a yacht 255 which is a main object and is recognized on the basis of an instruction by a user is located in a proper position according to the trisection method, that is, an image 250 in which the main object is located near a cross point of partitions in case the image is divided in three parts vertically and horizontally, than an image 260 in which a yacht 265 which is a main object is located in the center.

Further, the evaluation value acquiring unit 130 may acquire an evaluation value on the basis of whether or not a captured image is focused. Specifically, the evaluation value acquiring unit 130 decomposes an image signal showing a captured image into a plurality of frequency components by using a method such as fast Fourier transformation. Then, the evaluation value acquiring unit 130 acquires a lower evaluation value for an image of which the level of a high frequency component is low of the plurality of frequency components.

Further, the evaluation value acquiring unit 130 may acquire an evaluation value on the basis of whether or not red-eye is generated in case a main object is a human being. Specifically, the evaluation value acquiring unit 130 extracts an image of the face of the main object by using a method such as the pattern matching and simultaneously detects a region showing eyes in the image of the face. Then, the evaluation value acquiring unit 130 detects whether or not the red-eye is generated on the basis of color distribution of the eyes in the captured image and acquires a low evaluation value for the image in case the red-eye is generated.

Further, in case a main object is a human being, the evaluation value acquiring unit 130 may acquire an evaluation value on the basis of the direction of the eyes. Specifically, the evaluation value acquiring unit 130 extracts an image of the face of the main object by using a method such as the pattern matching and simultaneously detects a region showing the eyes in the image of the face. Then, the evaluation value acquiring unit 130 detects the direction of the main object's eyes by detecting the position of the center of the pupil from the image of the eyes of the captured image. Then, for example, the evaluation value acquiring unit 130 acquires a lower evaluation value for an image in which eyes of a main object turn to a direction different from a direction toward the camera than an image in which eyes of a main object turn to the camera.

Further, the evaluation value acquiring unit 130 may acquire an evaluation value on the basis of brightness of a captured image. Specifically, the evaluation value acquiring unit 130 acquires a lower evaluation value for an image in which a representative value of brightness such as an average value of brightness of pixels included in the captured image or a peak value in distribution of the brightness is out of a range predetermined by the user as a range of standard brightness than an image in which an representative value of brightness is included in the predetermined range. Thus, the evaluation value acquiring unit 130 can acquire a lower evaluation value for an image of underexposure or overexposure than an image of proper exposure.

Further, the evaluation value acquiring unit 130 may acquire an evaluation value on the basis of brightness of a main object. Specifically, the evaluation value acquiring unit 130 acquires a low evaluation value for an image in which a difference between a representative value of brightness such as an average value of brightness of pixels included in a part which is the main object and a representative value of brightness of another part is large. Thus, the evaluation value acquiring unit 130 can acquire a lower evaluation value for an image captured in a backlight situation in which the main object is quite dark comparing with the background than an image captured with illumination from the front.

Further, the evaluation value acquiring unit 130 may acquire an evaluation value on the basis of the size of distribution of brightness of an image included in a part which is a main object. More specifically, the evaluation value acquiring unit 130 may acquire a low evaluation value for an image in which a standard deviation of brightness of the image included in a part which is the main object is small. Thus, the evaluation value acquiring unit 130 can acquire a lower evaluation value for an image in which shade of the main object is distinguishable because a flash used when the image is captured is too intensive than an image captured by using a flash of proper intensity.

Further, the evaluation value acquiring unit 130 may acquire an evaluation value on the basis of color balance of a captured image. For example, the evaluation value acquiring unit 130 may acquire a higher evaluation value for an image as distribution of pixel values of the captured image is nearer to distribution predetermined as the user's favorite color balance.

Further, the evaluation value acquiring unit 130 may acquire an evaluation value on the basis of the kind of a main object. Specifically, the evaluation value acquiring unit 130 may acquire a higher evaluation value for an image as the image includes the main object showing greater importance. Further, the evaluation value acquiring unit 130 may detect the kind of the main object by comparing an image showing the main object and a pattern image predetermined for each kind of the main object. Thus, the evaluation value acquiring unit 130 can acquire the evaluation value according to the kind of the object on the basis of taste of the user.

Further, the evaluation value acquiring unit 130 may acquire an evaluation value on the basis of objects other than a main object. For example, in case the main object is a human being, the evaluation value acquiring unit 130 may acquire a lower evaluation value for an image as the number of objects which are persons different from the main object out of objects which are persons detected from the captured image. Further, for example, in case the main object is a human being, the evaluation value acquiring unit 130 may acquire a lower evaluation value for an image as a part showing an object which is a person other than the main object in the captured image is larger. Thus, the evaluation value acquiring unit 130 can acquire a higher evaluation value for an image as an object which the user thinks to be of no use is less distinguishing such as a person other than the main object in the image.

As above, although the reference and the method for acquiring the evaluation value has been described with respect to the evaluation value acquiring unit 130, the reference and the method for acquiring the evaluation value are not limited to the above and another reference and method may be used to acquire the evaluation value. For example, although the evaluation value acquiring unit 130 acquires a lower evaluation value for the image 210 in which the main object gets on the angry expression than the image 200 of the smiling expression, the evaluation value acquiring unit 130 may acquire a lower evaluation value for the image 200 than the image 210. Further, the evaluation value acquiring unit 130 may control to switch for which one of the images 200 and 210 to acquire a lower evaluation value on the basis of the user's instruction. Further, although the evaluation value acquiring unit 130 acquires a numerical number as the evaluation value in the present example, the evaluation value acquiring unit 130 may acquire one of a plurality of steps each of which has a predetermined width, such as A, B, C, etc. as the evaluation value.

In the mean time, the image processing unit 140 can perform the image processing by using various methods for reducing data amount of an image for which the evaluation value acquiring unit 130 acquires a low evaluation value. In the following, the image processing method of the image processing unit 140 is described by using an example.

The image processing unit 140 performs the image processing on a captured image by using a compression rate determined on the basis of the acquired evaluation value. Specifically, the image processing unit 140 performs the compression processing on an image of which evaluation value is lower than a predetermined reference value by using a higher compression rate than an image of which evaluation value is higher. Thus, the image processing unit 140 reduces data amount of the image of which evaluation value is low.

Further, the image processing unit 140 changes the gradation number of a captured image to a gradation number determined on the basis of the acquired evaluation value. Specifically, the image processing unit 140 performs a process of reducing a gradation number of each of A, G, and B of an image of which evaluation value is lower than a predetermined reference value so as to be changed from eight (8) bit to five (5) or six (6) bit. Thus, the image processing unit 140 reduces data amount of the image. In addition, the image processing unit 140 changes the resolution of a captured image to resolution determined on the basis of the acquired evaluation value. Specifically, the image processing unit 140 lowers the resolution of an image of which evaluation value is lower than a predetermined reference value and reduces data amount of the image, for example, by performing an image reduction processing and a trimming processing.

Although the method for reducing amount of image data of an image of which evaluation value is low the image processing unit 104 by the image processing unit 140 is described in the above, the method may be varied according to the acquired evaluation value, the compression rate of the image, the gradation number, and the resolution. For example, although the image processing unit 140 performs an image processing so as to reduce data amount of an image only in case an evaluation value of the image is lower than a predetermined reference value in the above description, the image processing unit 140 may perform the image processing regardless of the evaluation value. In this case, the image processing unit 140 may determine a compression rate, etc. by referring a database in which a compression rate, a gradation number, resolution, etc. are stored to correspond to each other.

Further, the image processing unit 140 may determine a compression rate, a gradation number, resolution, etc. of an image on the basis of available memory volume of the second memory 160 acquired by the memory volume detecting unit 170 in addition to the evaluation value. Specifically, the image processing unit 140 may restrain reduction amount of image data in case available memory volume is large by setting the compression raten to a low value as comparing with the case that available memory volume is small for images of which evaluation values are the same. Thus, in case a lot of memory of the second memory 160 is available, more images can be stored with better quality.

Further, the image processing unit 140 may make tag information on the basis of the acquired evaluation value and store the tag information so as to correspond to the image data in the second memory 160. For example, the image processing unit 140 may use the evaluation value as the tag information. Thus, the user can refer an evaluation value stored to correspond to a captured image and manage the image efficiently. Further, for example, the image processing unit 140 may determine whether or not the image data is open to the public through a network such as internet on the basis of the evaluation value and use the result as the tag information. In case the user opens an electronic album to the public through internet, etc, it is possible to make easily an electronic album of good quality by opening only an image in which a facial expression of a person which is a main object is proper and well-composed.

According to the digital camera 10 of the present embodiment, it is possible to reduce data amount of an image which the user judges to be of little importance efficiently and make the user use the image in the future by determining the compression rate, the gradation number, the resolution, etc. on the basis of the evaluation value acquired by the evaluation value acquiring unit 130.

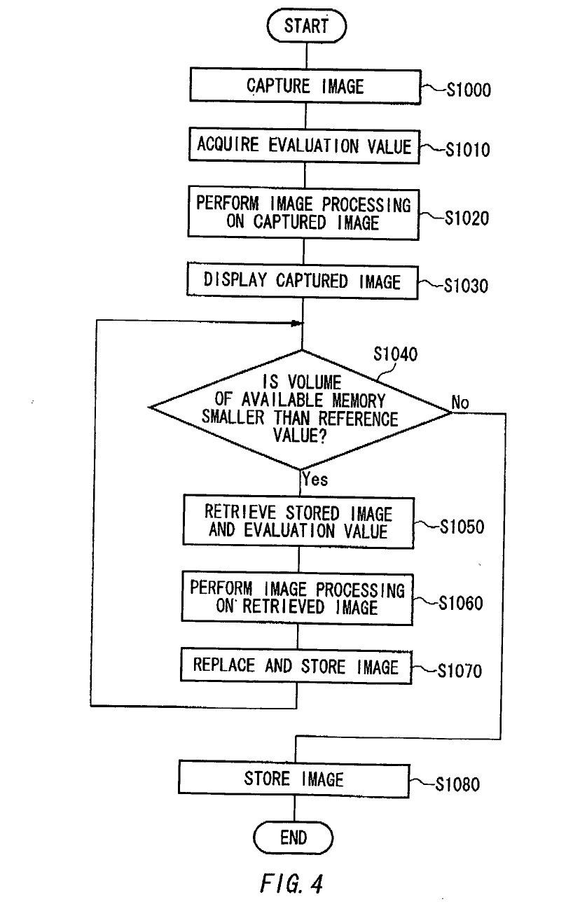

FIG. 4 is a flowchart showing a process flow of the digital camera 10 according to an embodiment of the present invention. First, the image capturing unit 100 captures an image of an object and stores data of the image in the first memory 110 (S1000) Then, the evaluation value acquiring unit 130 evaluates the image data stored in the first memory 110 by a predetermined reference and acquires an evaluation value (S1010). Then, the image processing unit 140 performs an image processing on the captured image on the basis of the acquired evaluation value (S1020) . Then, the display unit 150 displays the image on which the image processing is performed by the image processing unit 140 (S1030). Here, the image displayed by the display unit 150 may the image on which the image processing is performed on the basis of the evaluation value by the image processing unit 140 or the image before the image processing is performed on the basis of the evaluation value.

In the mean time, the memory volume detecting unit 170 detects whether or not available memory volume of the second memory 160 is smaller than a predetermined reference value (S1040). Here, the predetermined reference value may be memory volume of a predetermined ratio, for example, 10 percent (%) of the maximum available memory volume of the second memory 160, or, memory volume which is able to store data of a predetermined number of images, for example, five (5) pieces of images, of a standard size and quality.

In case the memory volume detecting unit detects that the available memory volume of the second memory 160 is smaller than the predetermined reference value (S1040; Yes), the image processing unit 140 retrieves the image which is previously captured and stored by the second memory 160 and the evaluation value corresponding to the image from the second memory 160 and stores them in the first memory 110 (S1050). Then, the image processing unit 140 performs an image processing on the image on the basis of the retrieved evaluation value corresponding to the image and reduces image data of the image (S1060). Then, the image processing unit 140 replaces the corresponding image stored in the second memory 160 with the image on which the image processing is performed and of which data amount is reduced and stores it (S1070). Then, the memory volume detecting unit 170 detects again whether or not the available memory of the second memory 160 is smaller than the reference value (S1040).

In the meantime, in case it is detected by the memory volume detecting unit that the available memory of the second memory 160 is larger than the predetermined reference value (S1040: No), the second memory 160 stores the image on which the image processing is performed by the image processing unit 140 so that the image corresponds to the evaluation value acquired by the evaluation value acquiring unit 130 (S1080).

According to the digital camera 10 of the embodiment, in case the available memory volume of the second memory 160 is small, it is possible to capture and store much more images by performing the image processing on the stored images on the basis of the evaluating values of the images and reducing the data amount. Therefore, it is possible to improve convenient of the user.

Further, according to the digital camera 10 of the embodiment, in case the captured image is stored in the second memory, it is not required to perform an acquisition processing of the evaluation value one more time for the stored image and it is possible to shorten the processing time, for example, when the image processing is performed on the basis of the evaluation value for the stored image, by storing the evaluation value acquired for the image so that the evaluation value corresponds to the image. Thus, a response of the digital camera 10 is promoted and convenient of the user is improved.

As described above, although the digital camera 10 captures a still image, the digital camera 10 may capture a moving picture. In this case, the evaluation value acquiring unit 130 may evaluate each of frame images of at least a part of the captured moving picture by a predetermined reference and acquire an evaluation value for the frame image, similarly with the description on FIGS. 1 to 4. Then, the image processing unit 140 may perform an image processing on the captured moving picture on the basis of the evaluation value acquired by the evaluation value acquiring unit 130. For example, the image processing unit 140 may perform a compression processing on the moving picture by using a lower compression rate than a moving picture including a frame image of which acquired evaluation value is higher. Further, for example, in case of reducing each of the frame images included in the moving picture to reduce data amount of the moving picture stored in the second memory 160, the image processing unit 140 may perform a reduction processing by using a lower reduction ratio than a moving picture including a frame image of which acquired evaluation value is lower.

Further, for example, the image processing unit 140 may perform the compression processing of the moving picture by using a frame image of which acquired evaluation value is higher as a key frame with higher priority. Thus, it is possible to restrain deterioration of quality of a frame image which the user judges to be of importance to the minimum and record a moving picture of high quality.

As above, even in the digital camera 10 captures a moving picture, it is possible to use memory volume of the second memory 160 more efficiently and improve quality of the moving picture to be stored by performing the image processing on the moving picture on the basis of importance judged by the user for the moving picture or a frame image included in the moving picture.

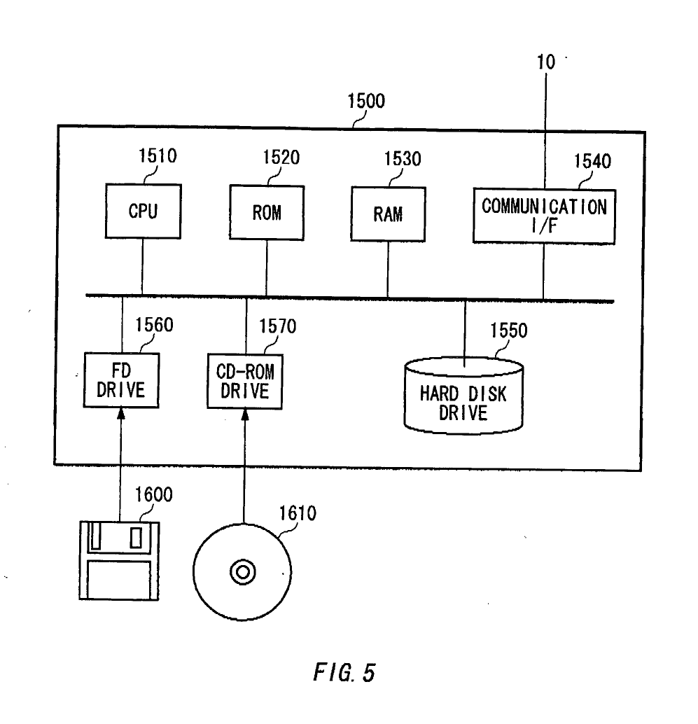

FIG. 5 is a block diagram showing an example of the configuration of a computer system 1500 according to an embodiment of the present invention. The computer system 1500 is connected to the digital camera 10 to have a program and data installed in the digital camera 10 and get image data and voice data from the digital camera 10. The computer system includes a CPU 1510, a ROM 1520, a RAM 1530, a communication interface 1540, a hard disk drive 1550, a flexible disk drive 1560, and a CD-ROM drive 1570. The CPU 1510 operates on the basis of a program stored in the ROM 1520 and the RAM 1530. The communication interface 1540 communicates with the digital camera 10 through a network. The hard disk drive 1550 stores a program making the CPU 1510 operate.

The flexible disk drive 1560 retrieves data or a program from a flexible disk 1600 and provides the CPU 1510 and the communication interface 1540 with it. The CD-ROM drive 1570 retrieves data or a program from a CD-ROM 1610 and provides the CPU 1510 and the communication interface 1540 with it. The communication interface 1540 transmits the data or the program provided by the flexible disk drive 1560 or the CD-ROM drive 1570 to the digital camera 10.

The program executed by the CPU 1510 and the program provided to the digital camera 10 are stored in the recording medium such as the flexible disk 1600 and the CD-ROM 1610 and provided to the user. The program executed by the CPU 1510 is installed in the hard disk drive 1550 from the recording medium and retrieved by the RAM 1530 to be executed by the CPU 1500. Instead, the program may be retrieved by the RAM 1530 directly from the recording medium to be executed by the CPU 1500.

Further, the program provided to the digital camera 10 is retrieved from the recording medium, installed in the digital camera 10 through the communication interface 1540, and executed in the digital camera 10. The program installed and executed in the digital camera 10 makes the digital camera 10 perform the functions described with respect to FIGS. 1 to 4 according to the operation of the digital camera 10.

An optical recoding medium such as a DVD, a PD, etc., a magneto-optical recording medium such as an MD, a tape medium, a magnetic recoding medium, a semiconductor memory such as an IC card, and a miniature card can be used as the recoding medium in addition to the flexible disk and the CD-ROM. Further, a storing apparatus such as a hard disk or a RAM provided in a server system connected with a dedicated communication network and internet may be used as the recording medium and may provide the digital camera 10 with the program through a communication network.

Although the present invention has been described by way of exemplary embodiments, it should be understood that those skilled in the art might make many changes and substitutions without departing from the spirit and the scope of the present invention which is defined only by the appended claims.

1. An image capturing apparatus comprising:
an image capturing unit for capturing an image;
an evaluation value acquiring unit for evaluating the image captured by said image capturing unit with a predetermined reference and acquiring an evaluation result as an evaluation value; and
an image processing unit for performing an image processing on the image captured by said image capturing unit on the basis of the evaluation value acquired by said evaluation value acquiring unit.

2. An image capturing apparatus as claimed in claim 1 further comprising a storing unit for storing the image on which the image processing is performed by said image processing unit by corresponding it to the evaluation value acquired by said evaluation value acquiring unit.

3. An image processing apparatus as claimed in claim 2 further comprising:
a memory volume detecting unit for detecting whether or not a memory volume available for usage of said storing unit is smaller than a predetermined value,
wherein said image processing unit further performs an image processing on the image on the basis of the evaluation value corresponding to the image stored by said storing unit in case the memory volume available for usage of said storing unit is detected not to be smaller than the predetermined value.

4. An image capturing apparatus as claimed in claim 1, wherein said image processing unit performs an image compression processing on the image captured by said image capturing unit by using an image compression rate determined on the basis of the evaluation value acquired by said evaluation value acquiring unit.

5. An image capturing apparatus as claimed in claim 1, wherein said image processing unit changes a gradation number of the image captured by said image capturing unit to a gradation number determined on the basis of the evaluation value acquired by said evaluation value acquiring unit.

6. An image capturing apparatus as claimed in claim 1, wherein said image processing unit changes a resolution of the image captured by said image capturing unit to a resolution determined on the basis of the evaluation value acquired by said evaluation value acquiring unit.

7. An image capturing apparatus as claimed in claim 1, wherein
said image capturing unit captures an moving picture,
said evaluation value acquiring unit evaluates each image of at least a part of frames of said moving picture by a predetermined reference and acquires the evaluation value for the frame image, and
said image processing unit performs the image processing on the moving picture on the basis of the acquired evaluation value.

8. An image capturing apparatus as claimed in claim 7, wherein said image processing unit performs an image compression processing on the moving picture by using a frame image of a higher evaluation value acquired as a key frame with higher priority.

9. An image capturing method comprising:
an image capturing step of capturing an image;
an evaluation value acquiring step of evaluating the image captured in said image capturing step with a predetermined reference and acquiring an evaluation result as an evaluation value; and
an image processing step of performing an image processing on the image captured in said image capturing step on the basis of the evaluation value acquired in said evaluation value acquiring step.

10. An image capturing method as claimed in claim 9 further comprising a storing step of storing the image on which the image processing is performed in said image processing step by corresponding it to the evaluation value acquired in said evaluation value acquiring step.

11. A machine readable medium storing thereon a computer program making an image capturing apparatus perform as the image capturing apparatus comprising:
an image capturing unit for capturing an image;
an evaluation value acquiring unit for evaluating the image captured by said image capturing unit with a predetermined reference and acquiring an evaluation result as an evaluation value; and
an image processing unit for performing an image processing on the image captured by said image capturing unit on the basis of the evaluation value acquired by said evaluation value acquiring unit.

12. A machine readable medium as claimed in claim 11, wherein the image capturing apparatus further comprising a storing unit for storing the image on which the image processing is performed by said image processing unit by corresponding it to the evaluation value acquired by said evaluation value acquiring unit.
